(19) United States
(12) Patent Application Publication
(10) Pub. No.: US 2005/0280497 A1
(43) Pub. Date: Dec. 22, 2005

(54) Fuse with metallic state indicator

(76) Inventor: John Marvin Ackerman, Belleville, IL (US)

Correspondence Address: John S. Beulick;Armstrong Teasdale LLP, Suite 2600, One Metropolitan Square, St. Louis, MO, 63102, US

(21) Appl. No.: 11/154,329

(22) Filed: Jun. 16, 2005

Related U.S. Application Data
(60) Provisional application No. 60/580,830, filed on Jun. 18, 2004.

(51) Int. Cl. H01H 85/30

(52) U.S. Cl. 337/206

(57) ABSTRACT

A fuse includes an insulative body, and at least one fuse state indicator extending upon an outer surface of the body. The indicator includes a conductive material applied directly to the outer surface of the body, and the indicator is formed with a weak spot of reduced cross sectional area.

### CROSS REFERENCE TO RELATED APPLICATIONS

This application claims the benefit of U.S. Provisional Application Ser. No. 60/580,830 filed Jun. 18, 2004.

### BACKGROUND OF THE INVENTION

This invention relates generally to fuses and, more particularly, to fuses with a fuse state indicator.

Fuses are widely used as overcurrent protection devices to prevent costly damage to electrical circuits. Fuse terminals typically form an electrical connection between an electrical power source and an electrical component or a combination of components arranged in an electrical circuit. A fusible link is connected between the fuse terminals, so that when electrical current flowing through the fuse exceeds a predetermined limit, the fusible link melts and opens the circuit through the fuse to prevent electrical component damage.

Fuse state indicators have been developed for various types of fuses to facilitate identification of inoperable fuses due to an opened fuse link. For example, a 220V plug fuse having a ceramic body and a conductive deposit extending on an outer surface of the body between end caps on either side of the body is known. The conductive deposit is electrically connected in parallel with a fuse element within the body, and when the fuse element opens in the event of a predetermined fault current, the voltage across the fuse element is applied to the conductive deposit on the outer surface of the body. A nonconductive deposit is applied over the conductive deposit, and the nonconductive deposit insulates the conductive deposit from the surrounding air to prevent arcing The conductive deposit bums out beneath the nonconductive deposit and discolors the nonconductive deposit to indicate the opening of the fuse element. This type of indicator is a rather difficult and expensive construction to implement, and a lower cost indicator is desired which is operable at higher voltages. Additionally, this type of indicator takes approximately one minute to fully operate, and faster acting indicators are desired.

Fuse state indicators are known which include conductive thin metallic films applied to a fuse as a label such that the metallic film applied to the label extends on an outer surface of an insulative fuse body. In such fuses, the labels extend on the outer surface of an insulative fuse body between conductive end caps or terminals, sometimes referred to as ferrules, that are attached to the opposite ends of the fuse body with a crimping operation. A conductive path is therefore established through the metallic film of the label for fuse state indication, and the conductive path through the metallic film is established in parallel with the primary fuse link. When the primary fuse element of the fuse operates to open the electrical circuit therethrough, current flows through the thin metallic film of the label which visibly indicates the operational state of the fuse. Opened fuses may therefore be readily identified and replaced.

While such indicator labels may be rather easily applied to fuses, termination of the thin metallic film of the labels to the ferrules of the fuse has proven problematic. It is difficult to attach the ferrules to the indicator without damaging the indicator. Conductive leads are sometimes provided to connect the indicator to the respective ferrules. The conductive leads, however, complicate the construction and manufacture of the fuse, as well as introduce potential reliability issues in operations.

Additionally, such fuse state indicators require that the fuses be installed in a predetermined position in the electrical system so that the indicator is visible for visual inspection of the indicator to determine the operating sate of the fuse. However, it can be difficult to install fuses in the proper orientation in an electrical system. If the indicator is not clearly visible once installed, the value of the indicator is greatly diminished, and the fuse must be removed from the electrical system so that the indicator may be inspected. Especially for systems having a large number of fuses, inconsistent installation of the fuses in the desired orientation can become an issue in effectively identifying opened fuses.

### BRIEF SUMMARY OF THE INVENTION

In an exemplary embodiment, a fuse comprises an insulative body, and at least one fuse state indicator extending upon an outer surface of the body. The indicator comprises a conductive material applied directly to the outer surface of the body, and the indicator is formed with a weak spot of reduced cross sectional area.

In another exemplary embodiment, a fuse is provided. The fuse comprises an insulative body, and at least one fuse state indicator extending upon an outer surface of the body. The indicator comprises a conductive paint applied directly to the outer surface of the body, and the indicator is formed with a weak spot having a different cross sectional area than a remainder of the indicator. A protective layer overlies the weak spot on the outer surface of the fuse.

According to another exemplary embodiment, a fuse is provided. The fuse comprises an insulative body, end caps coupled to the body, a primary fuse element extending within the body and electrically connected to the end caps, and at least one fuse state indicator extending upon an outer surface of the body. The indicator comprises a conductive paint applied directly to the outer surface of the body, and the indicator is formed with a weak spot of reduced cross sectional area. The indicator is electrically connected to the end caps in parallel with the primary fuse element.

### BRIEF DESCRIPTION OF THE DRAWINGS

FIG. 1 is a plan view of an exemplary embodiment of a fuse with a state indicator.

FIG. 2 is a cross sectional schematic view of the fuse shown in FIG. 1.

FIG. 3 is a plan view of a second exemplary embodiment of a fuse with a fuse state indicator.

### DETAILED DESCRIPTION OF THE INVENTION

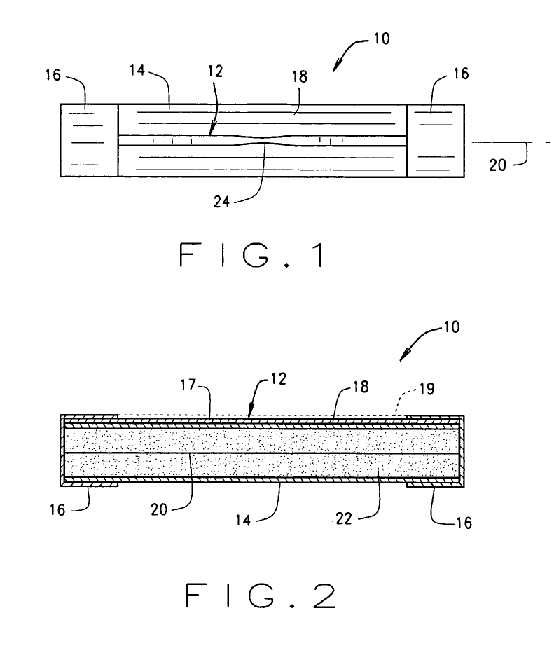

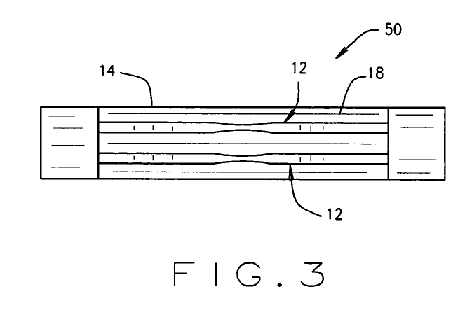

FIGS. 1 and 2 are a plan view and cross sectional view, respectively, of an exemplary embodiment of a fuse 10 with a state indicator 12. The fuse 10 may include an insulative fuse body 14 and conductive ferrules 16 attached thereto on either end thereof. The fuse state indicator 12 may extend on an outer surface 18 of the fuse body 14 and may be electrically connected to the ferrules 16.

The fuse body 14 may be fabricated from an insulative or nonconductive material, such as a known thermoplastic material in one embodiment, and the fuse body 14 is typically elongated in the direction of a longitudinal axis 20. The body 14 may be generally cylindrical or tubular as shown in the illustrated embodiment in FIGS. 1 and 2, although it is appreciated that the benefits of the instant invention may apply to non-cylindrical fuses, including but not limited to rectangular fuses, in alternative embodiments. It is understood that the invention may be applicable to a wide variety of fuses intended for a wide variety of applications and having a wide variety of fuse ratings. Therefore, the embodiments of the invention shown and described herein are for illustrative purposes only, and the invention is not intended to be restricted to a particular fuse type, class, or rating.

In an exemplary embodiment, the fuse state indicator 12 includes a conductive material 17 that is deposited directly on the outer surface 18 of the body 14 and is adapted to visually indicate the state of fuse 10 as operable or inoperable. A protective layer 19 (shown in phantom in FIG. 2) may be provided over the conductive material 17 as desired, and the protective layer 19 may be fabricated from a known insulative or nonconductive material to prevent inadvertent contact with the conductive material 17 or damage thereto which could impair the performance of the indicator 12. In one embodiment, the protective layer 19 may be a portion of a label applied to the body 14 of the fuse.

In an exemplary embodiment, the conductive material 17 of the indicator 12 may be a coating of conductive paint applied to the body 14 with a specified thickness depending on the rating of the fuse 10. Suitable conductive paint for the indicator 12 is commercially available from, for example, Spraylat Corporation of Pelham, N.Y. Pure silver paint is believed to be advantageous, but it recognized that copper-based paints or paints having other conductive materials therein may be employed.

The conductive material 17 may be directly applied to the body 14 in a thin film using, for example, a template (not shown) to form the conductive material 17 into a desired shape on the outer surface 18 of the body 14. Multiple thin films may be applied in succession one upon another to build up a thickness of conductive material 17 so that the a cross sectional area suitable for the voltage and current ratings of the fuse 10 is provided. The material 17 may be deposited on the body 14 using known techniques, including but not limited to spraying, printing, sputtered film deposition, and metal vapor deposition techniques. By directly applying the conductive material 17 to the outer surface 18 of the body 14, external adhesives, labels, etc. to attach the conductive material to the body 14 may be avoided and the manufacture of the fuse 10 may be simplified accordingly.

As illustrated in FIG. 1, the indicator 12 may be formed with a weak spot 24, or area of reduced cross sectional area relative to the remainder of the indicator 12, and the weak spot 24 may located approximately equidistant from the end caps 16. By providing the weak spot 24, the location of the weak spot more or less confines the opening of the indicator 12 to the location of the weak spot 24 when the indicator operates, as explained below. The location of the opening of the indicator is therefore more predictable than known metallic indicators that are typically formed with a constant cross sectional area.

Additionally, the weak spot 24 may be dimensioned to produce desired time response characteristics of the indicator 12, and fast acting indicators may be provided. A portion of the protective layer 19 may be transparent over the weak spot 24 to permit ready inspection of this area of the indicator 12.

The fuse state indicator 12, or more specifically the conductive material 17, may be electrically connected in parallel with a primary fuse element 20 (FIG. 2) extending between and electrically connected to each of the conductive ferrules 16. The primary fuse element 20 is a known fuse element, and in one embodiment has a voltage rating of approximately 600V. One or more weak spots or areas of reduced cross sectional area (not shown) may be provided in the fuse element 20. In alternative embodiments, a wire fuse link or other known fuse link construction may be employed as the primary fuse element 20. Additionally, more than one fuse element 20 may be employed in further embodiments of the invention.

The primary fuse element 20 is electrically connected to the ferrules 16 with solder or other known electrical connection technique, and when the conductive ferrules 16 are connected to line-side and load-side electrical circuitry (not shown), a current path is created through the primary fuse element 20 between the ferrules 16. The fuse state indicator 12 has a much higher electrical resistance than the primary fuse element 20 so that, during normal operation of the fuse 10, substantially all of the current passing through the fuse 10 passes through the primary fuse element 20. The fuse body 14 may be filled with an arc energy absorbing material 22, such as quartz sand, surrounding the primary fuse element 20. Quartz sand absorbs heat generated in the primary fuse element 20 in an overcurrent condition.

The fuse state indicator 12 may be electrically connected to the ferrules 16 and extends on the outer surface 18 of the fuse tube 14. The ferrules 16 are extended over the outer surface 18 of the fuse body 14 and end portions of the fuse state indicator 12, and the ferrules are, for example, crimped to the fuse body 14 to secure the ferrules to the fuse body 14 with the second portions 24. In another embodiment, the ferrules 16 are not crimped to the ends of the fuse body 14, but rather are mounted thereto with an adhesive sealing compound, such as a Loctite 660 compound familiar to those in the art.

Upon an occurrence of a predetermined magnitude of current corresponding to the current rating of the fuse 10, sometimes referred to as an overcurrent, and other times referred to as fault current, the primary fuse element 20 melts, vaporizes, disintegrates, or otherwise fails, thereby breaking or interrupting the current path and electrical connection through the primary fuse element 20. When the primary fuse element 20 opens, current is diverted into the conductive fuse state indicator 12. The conductive material 17 in the area of the weak spot 24 physically melts or disintegrates as the current flow therethrough after the fuse element 20 has opened. The fuse state is then visibly indicated via a physical transformation of the fuse state indicator 12, namely the presence or absence of the conductive material in the weak spot 24, when a substantial current flows therethrough when the primary fuse link 40 is opened. The presence of the conductive material indicates that the fuse in an operative or current carrying state providing fused protection, and the absence of the conductive material indicates that the fuse has opened due to an overcurrent or fault condition and is inoperative to complete the circuit through the fuse.

FIG. 3 illustrates another embodiment of a fuse 50 having multiple indicators 12 directly applied to and extending on the outer surface 18 of the fuse body 14 in spaced relation to one another. In one embodiment, the indicators 12 may be located approximately 90 radial degrees from one another on the surface 18 of the body 14, although the indicators 12 could be positioned closer together or farther apart in alternative embodiments. By providing more than one indicator 12 on the body 14, the fuse 50 may be oriented in multiple positions wherein at least one of the indicators 12 is visible, and it therefore is less likely that the indicators 12 will be obscured when the fuse 50 is installed than for the fuse 10 shown in FIGS. 1 and 2 having only one indicator 12. While two indicators 12 are illustrated in FIG. 3, it is appreciated that more than two indicators 12 may be provided in alternative embodiments without departing from the scope of the present invention.

Except for the provision of multiple indicators 12, the construction and operation of the fuse 50 is substantially the same as described above for the fuse 10.

Fuses 10 and 50 are therefore provided having relatively and low cost indicators 12 which are applied directly to the outer surfaces of the fuse bodies. Fast acting and reliable indicators may be obtained in an economical manner, and by providing multiple indicators in a single fuse, the value of the indicator is not as dependent upon the position of the fuse once installed. The indicator may reliably operate at higher voltages, for example up to about 600V, beyond the capability of known metallic indicators.

While the invention has been described in terms of various specific embodiments, those skilled in the art will recognize that the invention can be practiced with modification within the spirit and scope of the claims.

1. A fuse comprising:
an insulative body; and
at least one fuse state indicator extending upon an outer surface of the body, the indicator comprising a conductive material applied directly to the outer surface of the body, the indicator formed with a weak spot of reduced cross sectional area.

2. A fuse in accordance with claim 1 wherein the indicator comprises a thin film conductive paint directly applied to the outer surface of the fuse.

3. A fuse in accordance with claim 1 wherein the conductive material comprises silver.

4. A fuse in accordance with claim 1 further comprising a protective layer extending over the weak spot.

5. A fuse in accordance with claim 1 wherein the at least one indicator comprises a first indicator and a second indicator spaced from one another on the outer surface of the body.

6. A fuse in accordance with claim 1 further comprising conductive end caps secured to the body, wherein the at least one fuse indicator is electrically connected to the end caps.

7. A fuse in accordance with claim 1 further comprising a primary fuse element, the at least one fuse state indicator electrically connected in parallel with the primary fuse element.

8. A fuse in accordance with claim 1 wherein the fuse body is substantially cylindrical.

9. A fuse comprising:
an insulative body;
at least one fuse state indicator extending upon an outer surface of the body, the indicator comprising a conductive paint applied directly to the outer surface of the body, the indicator formed with a weak spot having a different cross sectional area than a remainder of the indicator; and
a protective layer overlying the weak spot on the outer surface of the fuse.

10. A fuse in accordance with claim 9 wherein the conductive paint comprises silver.

11. A fuse in accordance with claim 9 wherein the at least one indicator comprises a first indicator and a second indicator spaced from one another on the outer surface of the body.

12. A fuse in accordance with claim 9 further comprising conductive end caps secured to the body, wherein the at least one fuse indicator is electrically connected to the end caps.

13. A fuse in accordance with claim 9 further comprising a primary fuse element, the at least one fuse state indicator electrically connected in parallel with the primary fuse element.

14. A fuse in accordance with claim 9 wherein the fuse body is substantially cylindrical.

15. A fuse comprising:
a substantially cylindrical body fabricated a nonconductive material;
end caps coupled to the body;
a primary fuse element extending within the body and electrically connected to the end caps; and
at least one fuse state indicator extending upon an outer surface of the body, the indicator comprising a conductive paint applied directly to the outer surface of the body, the indicator formed with a weak spot of reduced cross sectional area, and the indicator electrically connected to the end caps in parallel with the primary fuse element.

16. A fuse in accordance with claim 15 further comprising a protective coating overlying the weak spot on the outer surface of the fuse.

17. A fuse in accordance with claim 15 wherein the at least one indicator comprises multiple indicators spaced from one another on the outer surface of the body.

18. A fuse in accordance with claim 17 wherein the multiple indicators includes two indicators located approximately 90 degrees from one another on the outer surface of the body.
